(19) United States
(12) Patent Application Publication
(10) Pub. No.: US 2011/0311842 A1
(43) Pub. Date: Dec. 22, 2011

(54) ELECTRIC CELL ARRANGEMENT

(76) Inventor: Jang-Chung FANG, Taipei City (TW)

(21) Appl. No.: 12/817,200

(22) Filed: Jun. 17, 2010

(51) Int. Cl. H01M 14/00; H02J 7/00; H01M 6/42

(52) U.S. Cl. 429/7; 429/156; 307/150; 307/10.1

(57) ABSTRACT

An electric cell arrangement includes a plurality of secondary batteries connected in series with each other. With a combination of secondary batteries of different types, the electric cell arrangement provides a range of operating voltage and a capacity that is better fit for the need of an electric power consuming device.

### TECHNICAL FIELD OF THE INVENTION

The present invention generally relates to an electric cell arrangement, which comprises serial connection of secondary batteries of various types to provide an optimum range of operating voltage to be supplied to equipment that requires a supply of stabilized voltage, such as automobiles, motorcycles, emergency power generators, uninterrupted power supplies, or the likes.

### DESCRIPTION OF THE PRIOR ART

With the quick development of science and technology, various hand-held or portable electronic devices and power-operating devices are getting popular. However, most of these devices are powered by electric cells or batteries. This makes the consumption of electric cells quickly increased day by day.

Electric cells/batteries are classified as follows, according to the characteristics of charging/discharging and the applications thereof:

(1) Primary cell is an electric cell simply for use one time and the chemical energy of the primary cell that was consumed cannot be restored through a charging process, so that it is named disposable battery. Electric cell of this type includes a dry battery, a mercury battery, and an alkaline battery. The primary cell has the widest and earliest application among all types of electric battery. Most of non-rechargeable batteries that are available in the market are this type, such as the button cells and AAA, AA, and A cells.

(2) Secondary battery is an electric cell that can be repeatedly used. Through a charging process, active substances contained in a secondary battery can be restored to the original forms for re-supplying electric power. Electric cells of this type include a lead acid battery, a nickel cadmium battery, a nickel hydrogen battery a secondary lithium battery a lithium ion battery, and a polymer lithium battery.

(3) Fuel cell is substantially different from the above two electric cells and is also referred to as a successive electrochemical cell. A fuel cell contains no active substances at positive and negative electrodes, and instead, a continuous supply of active substance is required to maintain continuous discharging of electrical power from the cell. The positive electrode of a fuel cell carries out an oxidation reaction which air or oxygen participates in, and the negative electrode carries out a reaction which hydrogen or coal gas participates in. Electric cells of this type include hydrogen oxygen fuel cell.

The primary cell is advantageous in low costs, easy manufacturing, low self-discharge rate, high power/weight ratio (50-80 Wh/Kg), and easy carrying and thus, the primary cell is of the greatest production and widest application. However, the primary cell is disadvantageous for its small power, making it unfit for applications of large current discharging. Due to that the fuel cell is still under development and is subjected to limitation of being bulky in size, the fuel cell is often used in power generation system or serving as a backup power supply. Thus, for applications of large current discharging and applications requiring repeated use, the most commonly used one is the secondary battery.

Taking an automobile used secondary battery as an example, an automobile has a power generator that is an alternate current power generator, which supplies an alternate current that is subjected to full wave rectification to provide electrical voltage in the form shown in FIG. 1, wherein peaks indicate the highest voltage generated by the generator, which is usually 14.2V for lithium iron phosphate batteries, while the lowest voltage is the potential of a lead acid battery of the automobile, which is around 12.4-12.8V depending the capacity of power storage of the battery. Consequently, each time a spark plug makes ignition, the electrical voltage changes between 12.4-14.2V, depending on the voltage supplied from the power generator at the time of ignition of an engine cylinder. This leads to instability of voltage in ignition of each cylinder of the automobile engine, so that diverse intensity of sparking may results, giving unstable power output and excessive consumption of fuel.

Since the automobile engine is often composed of four cylinders, such an unstable power output is often not sensed by a driver. Such an unstable power output is not caused by power or erroneous designs of the automobile manufacturers, but rather originates from the inherent characteristics of charging/discharging of the lead acid battery. The charge voltage of a lead acid battery is around 13-15V, while the discharge is approximately 9-13V. The automobile manufacturers often use a power generator of 14.2V for automobiles and consequently, all the electronic/electrical parts of the automobiles must match a voltage of 14.2V.

To improve the problem of instability of voltage supplied from a lead acid battery, a small-capacity lithium battery connected in parallel with the lead acid battery, or alternatively, a large-capacity lithium battery replaces the lead acid battery. Due to the expensive costs, the large-capacity lithium battery is not an economic option. On the other hand, if a lithium battery is connected in parallel with a lead acid battery, the range of operating voltage required is 12.4-15V. This makes it impossible to adjust the range of operating voltage of a single, specific type of lithium battery to a desired range. For example, four lithium manganese batteries connected in series provide an operating voltage in the range of 12-16.8V, of which the lowest voltage, 12V, is very close to the low voltage bound of the lead acid battery, which is 12.4V, making it easy to over discharge and thus resulting in damages. If three lithium manganese batteries are used instead, then the range of operating voltage is 9-12.6V, which makes it possible for the batteries to be over charged by the high voltage supplied from the generator and thus damaged. If four lithium iron batteries connected in series are used instead, the range of operating voltage is 8-13.6V, of which the highest voltage does not meet the need of 15V for automobile, but five lithium iron batteries connected in series provide a range of operating voltage between 10-17V, of which the lowest voltage is close to the 12.4V low voltage bound of the lead acid battery (12.4V/5=2.48V), whereby when a large current is consumed in the ignition of an automobile engine, the batteries may get over-discharging and damage may result. Apparently, improvement in this respect is needed.

### SUMMARY OF THE INVENTION

The primary objective of the present invention is to provide an electric cell arrangement, which combines electric batteries having at least two different operating voltages to provide an optimum range of operating voltage.

Another objective of the present invention is to provide an electric cell arrangement, which allows for easy combination of electric batteries through simple calculation so as to realize an optimum condition of output voltage of the electric cell arrangement.

To achieve the above objectives, the present invention provides an electric cell arrangement, which is characterized in that a plurality of secondary batteries of at least two different types are connected in series with each other, or alternatively, the secondary batteries are connected in series with an electric capacitor, in order to set a range of combined operating voltage and capacity to better fit to the need of a power consuming device.

The electric cell arrangement according to the present invention comprises secondary batteries of at least two types, which are selectively lithium cobalt battery lithium manganese battery, lithium iron battery, lead acid battery, nickel cadmium battery and nickel hydrogen battery.

The electric cell arrangement according to the present invention is selectively combined with a protection circuit to provide protection to each individual battery, so that the battery is not damage in the course of electric discharge, or alternatively, the electric cell arrangement is used without the protection circuit.

The electric cell arrangement according to the present invention may comprise a protection circuit that comprises a bypass resistor, which is connected in parallel with each of the second batteries, a detection IC (Integrated Circuit), which is electrically connected to each of the secondary batteries.

The present invention provides an electric cell arrangement that offers at least the following advantages:

(1) A combination of batteries having different operating voltages is made as desired to provide an optimum range of operating voltage that best fit for the need of an electric power consuming device, such as an automobile, a motorcycle, an emergency power generator, an uninterrupted power supply, or the like, making the electric power consuming device operating smoothly.

(2) The low voltage bound of an electric battery assembly is maintained around a nominal voltage, so that over-discharging caused by large current activation can be eliminated, to ensure the supply of stable voltage from the electric battery assembly.

(3) A protection circuit is included, if necessary, to selectively protect an individual battery with respect to the electric characteristics thereof, so that the battery may not be damaged in the course of charging and discharging.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a waveform of voltage supplied from a power generator of an automobile after subjected to full wave rectification.

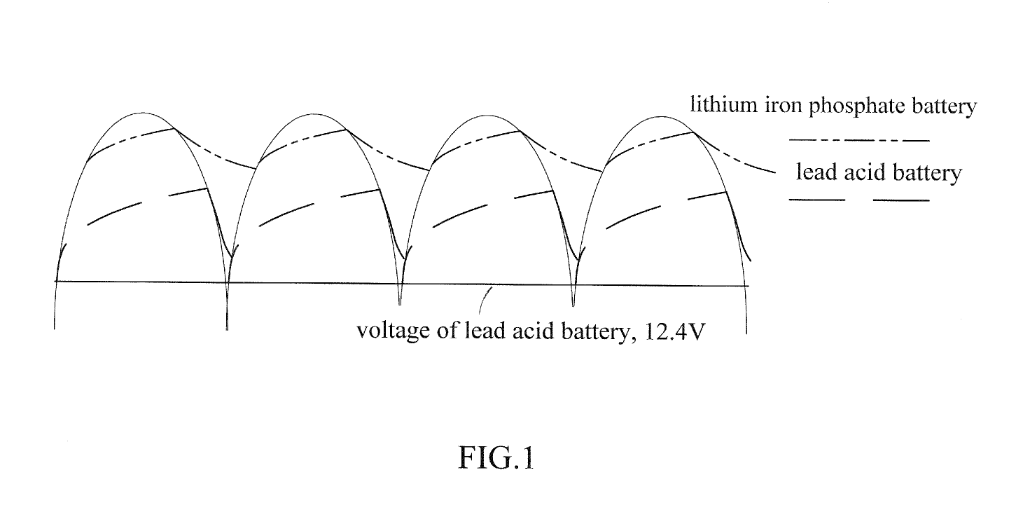

FIG. 2 shows a circuit diagram of an electric cell arrangement according an embodiment of the present invention.

FIG. 3 shows a waveform of voltage applied to an automobile incorporating the electric cell arrangement of the present invention.

FIG. 4 shows the application of the electric cell arrangement of the present invention to an automobile.

FIG. 5 shows a circuit diagram of an electric cell arrangement according a different embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention provides an electric cell arrangement, which comprises, according to a desired operating voltage of an electric power consuming device to which the electric cell arrangement supplies electric power, a plurality of secondary batteries of at least two different types connected in series. An automobile is taken as an example in the following description and when a lithium battery is used in parallel connection with a lead acid battery, it can use both the advantage of low cost and large capacity of the lead acid battery and the characteristics of fast discharging and charging of the lithium battery to maintain the voltage supplied to the automobile around the highest voltage of a power generator of the automobile, so that the ignition voltage of spark plugs can be kept at an optimum condition, where the range of operating voltage of the electric cell arrangement is between 12.4-15V, of which 12.4V is the low voltage bound of the lead acid battery, while 15V is the highest voltage from of the power generator. However, the conventional way of using a single battery does not allow for adjustment to provide the desired range of operating voltage.

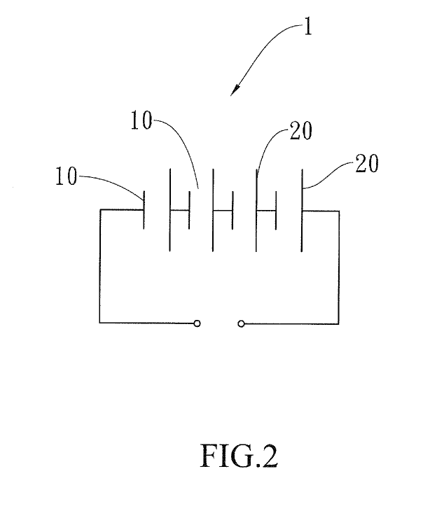

Reference is now made to FIG. 2. According to the present invention, an electric cell arrangement, generally designated at 1, is provided, comprising two lithium manganese batteries 10 and two lithium iron batteries 20 connected in series. The lithium manganese battery 10 provides an electric voltage of 4.2-3V, while the lithium iron battery 20 provides an electric voltage of 3.4-2V. To ensure that the batteries can provide an effective electric power, the voltage of the batteries must be greater than a nominal voltage, and thus, the voltage of the lithium manganese battery 10 is taken as 4.2V and that of the lithium iron battery 20 is 3.4V. This makes the electric voltage of the electric cell arrangement 1 equal to 4.2V×2+3.4V×2=15.2V. Under such a condition, the greatest durable voltage of the electric cell arrangement 1 is 15.2V, which exceeds the highest voltage 15V that can be supplied from the power generator. It is not possible to cause over-charging. When the automobile is parked and the engine shut down, the lithium batteries, due to providing a voltage greater than the lead acid battery, continuously charge the lead acid battery to eventually reach a balance of voltage with respect to the lead acid battery. Under the assumption that the low voltage bound of the lead acid battery is 12.4V, the voltage of the lithium batteries can be considered as a distribution of 3.5V×2+2.7V×2=12.4V, where the lowest voltage is maintained around the nominal voltage and over-discharging due to large current activation is prevented.

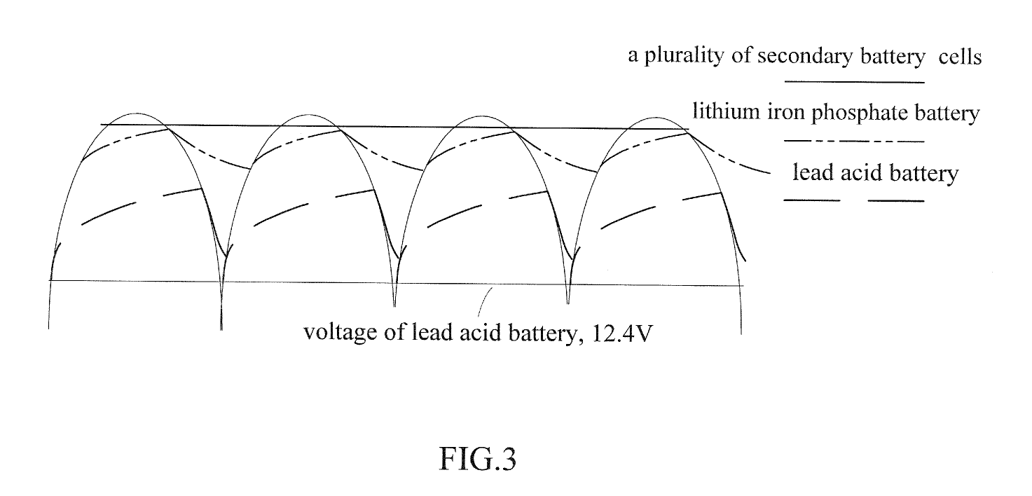

Referring to FIG. 3, when the electric cell arrangement 1 is composed of a plurality of secondary batteries as shown in the drawings, the operating voltage of the electric cell arrangement 1 is greater than a lithium iron phosphate battery and a lead acid battery, the greater operating voltage causes the spark plugs to generate greater ignition sparks so that complete combustion showing improved efficiency can be realized to provide a saving of 10-15% of fuel expense. Since the electric cell arrangement 1 is a combination of secondary batteries of two different types, such as two lithium manganese batteries 10 and two lithium iron batteries 20, connected in series, so that the range of charging and discharging of the operating voltage is 10-15.2V. Further, the electric cell arrangement 1 may be such that the secondary batteries are connected in series with an electric capacitor. When the electric cell arrangement 1 gets saturated, the operating voltage can reach the highest voltage that can be supplied from the power generator, so that the range that the operating voltage may shift can be substantially reduced and powerful and uniform ignition can be realized by the spark plugs in each time of ignition, making the combustion more complete and power output stable so that fuel consumption is reduced.

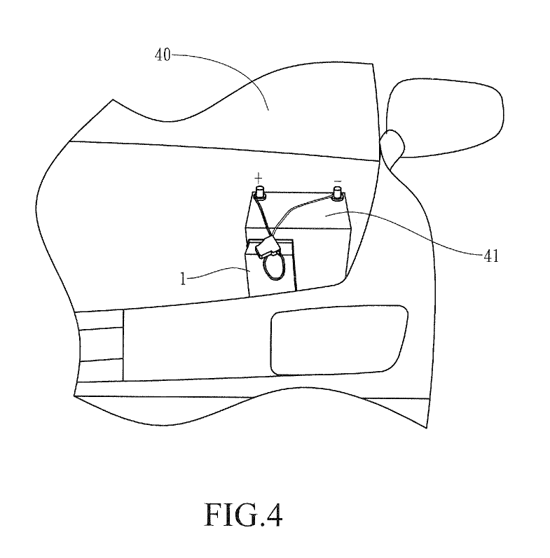

Referring to FIG. 4, an application of the electric cell arrangement 1 according to the present invention is shown connected to an automobile battery 41 of an automobile 4. Under this condition, the power system of the automobile completely matches the perfect design of the automobile manufacturer, allowing the engine to supply complete power output. However, it is apparent that the electric cell arrangement 1 according to the present invention can be alternatively connected to a motorcycle, an emergency power generator, an uninterrupted power supply, or the likes.

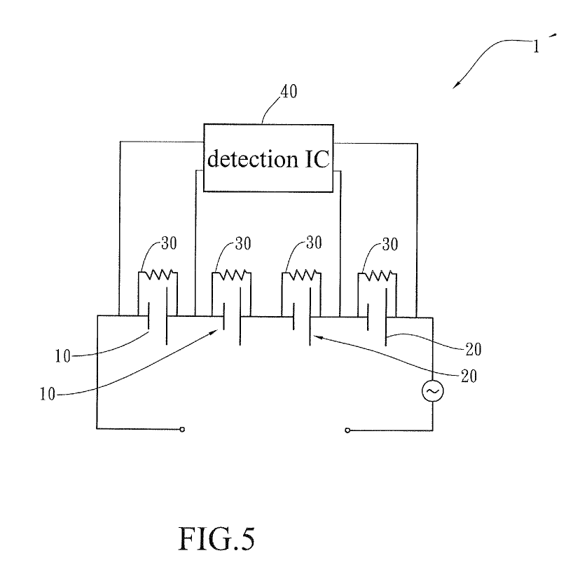

Referring to FIG. 5, in a different embodiment, the present invention provides an electric cell arrangement, which is generally designated at 1′, and the electric cell arrangement 1′ is composed of two lithium manganese batteries 10 and two lithium iron batteries 20 in combination with a protection circuit. Thus, protection can be made for an individual battery to protect the battery from damage caused in the course of charging and discharging. The protection circuit comprises a bypass resistor 30, which is connected in parallel with each of the secondary batteries, and a detection IC (Integrated Circuit) 40, which is eclectically connected to each of eth secondary batteries.

Reference is now made the following Table 1, which lists certain data of experiment results for the electric cell arrangement according to the present invention applied to an automobile.

TABLE 1

| | | | fuel | saving |
|---|---|---|---|---|
| | | | consumption | of fuel |
| date | installed or not | kilometerage | (Km/L) | (percentage) |
| 2009/10/7 | not installed | 71.4 | 10.55 | |
| | installed | 71.2 | 11.89 | 12.7% |
| 2009/10/8 | not installed | 71.3 | 12.13 | |
| | installed | 71.2 | 13.76 | 13.33% |
| 2009/10/9 | not installed | 71.3 | 12.31 | |
| | installed | 71.3 | 13.79 | 12.03% |
| 2009/10/10 | not installed | 77.7 | 10.00 | |
| | installed | 109.8 | 10.00 | 12.25% |
| 2009/10/20 | not installed | 99.3 | 10.00 | |
| | installed | 112.7 | 10.00 | 14.15% |
| 2009/10/21 | not installed | 100.1 | 10.00 | |
| | installed | 115.1 | 10.00 | 15.00% |

It can be observed from Table 1 that an automobile equipped with the electric cell arrangement according to the present invention shows an apparent increase of the kilometerage per liter of fuel and an average increase rate is greater than 10%. The automobile can travel 1.43 more kilometers with each liter of fuel, giving a saving of fuel of 13.17%.

Reference is now made the following Table 2, which lists certain data of exhaust inspection for an automobile that incorporates the electric cell arrangement according to the present invention.

TABLE 2

| Item | HC (g/Km) | CO (g/Km) | NO (g/Km) |
|---|---|---|---|
| before installation | 0.2861 | 5.9134 | 0.3540 |
| after installation | 0.2739 | 4.2102 | 0.2837 |
| amount of improvement | 0.0122 | 1.7032 | 0.0703 |
| percentage of improvement | 4.26% | 28.8% | 19.86% |
| (%) | | | |

It can be observed from Table 2 that when an automobile is equipped with the electric cell arrangement of the present invention, the exhaust emission from the automobile, including CO, HC, and NO, can be substantially reduced.

It is further noted that when an automobile is equipped with the electric cell arrangement of the present invention, the automobile is supplied with a higher operating voltage and the exhaust emission from the automobile contains no benzene, indicating better result of combination.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An electric cell arrangement, characterized by:
comprising a plurality of secondary batteries of at least two different types connected in series,
wherein the types of the secondary batteries selectively comprise a lithium manganese battery and a lithium iron battery.

2. The electric cell arrangement according to claim 1 further comprising an electric capacitor connected in series with the secondary batteries.

3. The electric cell arrangement according to claim 1, wherein the types of the secondary batteries selectively comprise lithium cobalt battery, lead acid battery, nickel cadmium battery, and nickel hydrogen battery.

4. The electric cell arrangement according to claim 3, wherein the secondary batteries are electrically connected to a protection circuit, wherein the protection circuit comprises:
a bypass resistor, which is connected in parallel with each of the secondary batteries; and
a detection IC, which is electrically connected to each of the secondary batteries.

5. An automobile comprising an electric cell arrangement according to claim 1.

6. The automobile according to claim 5, wherein the automobile comprises an automobile battery connected in parallel with the electric cell arrangement.

7. The automobile according to claim 5 further comprising an electric capacitor connected in series with the secondary batteries.

8. The automobile according to claim 5, wherein the secondary batteries are electrically connected to a protection circuit, wherein the protection circuit comprises:
a bypass resistor, which is connected in parallel with each of the secondary batteries; and
a detection IC, which is electrically connected to each of the secondary batteries.

9. A motorcycle comprising an electric cell arrangement according to claim 1.

10. The motorcycle according to claim 9, wherein the motorcycle comprises a battery connected in parallel with the electric cell arrangement.

11. The motorcycle according to claim 9 further comprising an electric capacitor connected in series with the secondary batteries.

12. The motorcycle according to claim 9, wherein the secondary batteries are electrically connected to a protection circuit, wherein the protection circuit comprises:
a bypass resistor, which is connected in parallel with each of the secondary batteries; and
a detection IC, which is electrically connected to each of the secondary batteries.
